(19) United States
(12) Patent Application Publication
(10) Pub. No.: US 2025/0381426 A1
(43) Pub. Date: Dec. 18, 2025

(54) SMART SYSTEM FOR EVACUATION AND RESCUE SUPPORT IN CASE OF LARGE BUILDING DISASTER AND OPERATION METHOD FOR SMART SYSTEM

(71) Applicant: CORNERS CO., LTD., Seoul (KR)

(72) Inventors: Jang Won Choi, Seoul (KR); Dong Oh Kim, Seoul (KR); Tae Kyu Han, Seoul (KR); HoJung Lim, Seoul (KR); Joohyoung Lee, Seoul (KR)

(73) Assignee: CORNERS CO., LTD., Seoul (KR)

(21) Appl. No.: 18/821,524

(22) Filed: Aug. 30, 2024

(30) Foreign Application Priority Data
Jun. 18, 2024 (KR) 10-2024-0078592

(51) Int. Cl. A62B 3/00; A62B 5/00; A62B 31/00

(52) U.S. Cl. CPC A62B 3/00; A62B 5/00; A62B 31/00; B25J 9/1674; B25J 13/08; B25J 19/06; B61B 12/005; G06Q 90/205; G08B 7/062; G08B 7/066

(57) ABSTRACT

A smart system for evacuation and rescue support in case of a large building disaster and an operation method for the smart system are disclosed. In an embodiment, a smart system deployed in a large building includes: a communication part that, in the event of an emergency situation, receives information on an emergency situation from an integrated control center of the large building; a sensing part including at least one camera; an output part that outputs information; a driving part that moves the smart system; a boarding part for getting a user in the large building aboard; and a control part that controls the communication part, the sensing part, the output part, and the driving part, wherein the control part determines crowdedness by analyzing an image inputted through the at least one camera, operates in a kiosk mode and outputs information through the output part, if the crowdedness is equal to or above a preset threshold, operates in a rescue mode and moves the smart system through the driving part, if the crowdedness is below the preset threshold, and searches for a mobility handicapped person or a person in need of rescue by analyzing an image inputted through the at least one camera.

### CROSS-REFERENCE TO RELATED APPLICATION

This application is based on and claims priority under 35 U.S.C. 119 to Korean Patent Application No. 10-2024-0078592, filed on Jun. 18, 2024 in the Korean intellectual property office, the disclosures of which are herein incorporated by reference in their entireties.

### TECHNICAL FIELD

The following description relates to a smart system for evacuation and rescue support in case of a large building disaster and an operation method for the smart system.

### BACKGROUND OF THE DISCLOSURE

As subway and train stations become deeper and numbers of complex transfer stations, the subway and train stations are increasingly becoming complex in structure. This increase in the structural complexity of stations can lead to a high potential for bottlenecks in case of a disaster at a station, and can lengthen the time it takes for evacuation, thus causing more damage when a bottleneck occurs. This issue also applies similarly to various large buildings such as large-scale complex facilities, as well as stations.

Moreover, although there are evacuation lights placed in a large building for use in case of a large building disaster to indicate the direction to a nearby exit, they might be misleading information for evacuees if there is a dangerous area in that direction. Also, evacuation lights have an awareness rate of only 38%, so it is hard to expect people to evacuate from their locations by themselves in a distributed manner.

In addition, even if safety management personnel might provide guidance about what the initial situation is and where dangerous areas are, at an initial stage of a disaster, they will not be able to inform about how dangerous areas continue to grow in size and number, and there are difficulties in deploying safety personnel to give guidance rapidly and effectively, since the number of safety management personnel is nowhere near the number of evacuees.

Furthermore, asphyxial deaths caused by inhalation of smoke containing toxic gases account for 70% of deaths from fire, and it is highly likely that evacuees may encounter smoke during evacuation because smoke spreads fast both vertically and horizontally. Even breathing in toxic gases from fire only once or a couple of times can make people faint, and they will hardly survive if left in smoke until a rescue team arrives. Besides, considering that the critical time of fire is about 5 minutes, it is quite difficult to escape safely within this period when a fire occurs in a large-city station which is an often a deep underground, complex structure.

### PRIOR ART DOCUMENT

Korean Patent Registration No. 10-2643853

The aforementioned information is to merely help understanding, and may include contents which do not form a part of a conventional technology.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

The present disclosure provides a smart system for evacuation and rescue support in case of a large building disaster and an operation method for the smart system.

An embodiment of the present disclosure provides a smart system deployed in a large building, including: a communication part that, in the event of an emergency situation, receives information on an emergency situation from an integrated control center of the large building; a sensing part including at least one camera; an output part that outputs information; a driving part that moves the smart system; a boarding part for getting a user in the large building aboard; and a control part that controls the communication part, the sensing part, the output part, and the driving part, wherein the control part determines crowdedness by analyzing an image inputted through the at least one camera, operates in a kiosk mode and outputs information through the output part, if the crowdedness is equal to or above a preset threshold, operates in a rescue mode and moves the smart system through the driving part, if the crowdedness is below the preset threshold, and searches for a mobility handicapped person or a person in need of rescue by analyzing an image inputted through the at least one camera.

According to one aspect, the crowdedness may be determined based on the number of users identified through an image inputted through the at least one camera, in such a manner that, the more the users, the higher the level of crowdedness.

According to another aspect, in the kiosk mode, the control part may output information on the location of the emergency situation and information on the direction of evacuation through the output part as information on the emergency situation.

According to yet another aspect, in the rescue mode, the control part may output information for guiding a found mobility handicapped person aboard the boarding part through the output part, and once the mobility handicapped person is aboard the boarding part, may control the transportation of the mobility handicapped person to a safe zone by controlling the driving part.

According to a further aspect, the control part may additionally search for a person in need of rescue while moving to the location of a found person in need of rescue.

According to a further aspect, the smart system may further include a provision part providing a marking device configured to output visual or auditory information, wherein the control part deploys the marking device at the location of the found person in need of rescue by controlling the provision part, and sends information on the location to the integrated control center through the communication part.

According to a further aspect, the smart system may further include a provision part that provides a breathing aid capable of blocking smoke or supplying oxygen, wherein the control part provides the breathing aid to the found person in need of rescue through the provision part.

According to a further aspect, the control part may control the smart system in such a way as to stay on standby around the found person in need of rescue while outputting visual or auditory information through the output part.

According to a further aspect, the boarding part may be transformed into a configuration that allows the user to board as components disposed inside the smart system are pulled out of the smart system according to control from the control part.

According to a further aspect, the at least one camera may include an upper camera for detecting a descent of smoke from above the smart system, and the control part detects smoke descending to a preset height or lower by analyzing an image inputted through the upper camera, and, upon detecting a descent of smoke, may output through the output part information for prompting users to bend down during evacuation.

According to a further aspect, upon detecting a descent of smoke, the control part may provide a breathing aid to a detected mobility handicapped person or person in need of rescue.

Another embodiment of the present disclosure provides a smart system deployed in a large building, including a communication part, at least one camera, a driving part, and a control part, wherein, by means of the control part, the smart system receives information on an emergency situation through the communication part, determines crowdedness by analyzing an image inputted through the at least one camera in the event of an emergency situation, and determines whether or not to move through the driving part of the smart system depending on whether the crowdedness is below a preset threshold.

A yet another embodiment of the present disclosure provides an operation method for a smart system deployed in a large building, the smart system including a communication part, a sensing part, an output part, a driving part, a boarding part, and a control part, and the operation method including:

receiving information on an emergency situation from an integrated control center of the large building through the communication part in the event of an emergency situation; determining crowdedness, by means of the control part, by analyzing an image inputted through at least one camera included in the sensing part; if the crowdedness is equal to or above a preset threshold, operating in a kiosk mode and outputting information through the output part, by means of the control part; if the crowdedness is below the preset threshold, operating in a rescue mode and moving the smart system through the driving part, by means of the control part; and searching for a mobility handicapped person or a person in need of rescue, by means of the control part, by analyzing an image inputted through the at least one camera.

The present disclosure may provide a smart system for evacuation and rescue support in case of a large building disaster and an operation method for the smart system.

### DESCRIPTION OF THE DRAWINGS

The foregoing aspects and many of the attendant advantages of this disclosure will become more readily appreciated as the same become better understood by reference to the following detailed description, when taken in conjunction with the accompanying drawings, wherein:

FIGS. 1 to 3 are views illustrating an example of implementation of a smart system according to an embodiment of the present disclosure.

FIG. 4 is a view illustrating an example of functions of a smart system in a disaster situation according to an embodiment of the present disclosure.

FIG. 5 is a view illustrating an example of functions of a smart system in a normal situation according to an embodiment of the present disclosure.

FIG. 6 is a view illustrating an example of an internal configuration of a smart system according to an embodiment of the present disclosure.

FIGS. 7 to 9 are views illustrating an example of an operation scenario of a smart system according to an embodiment of the present disclosure.

FIG. 10 is a view illustrating an example of an outward appearance of a smart system according to an embodiment of the present disclosure.

FIG. 11 is a view illustrating an example of a smart system in a kiosk mode according to an embodiment of the present disclosure.

FIG. 12 is a view illustrating an example of a smart system in a rescue mode according to an embodiment of the present disclosure.

FIG. 13 is a view illustrating an example of providing an air shield according to an embodiment of the present disclosure.

FIGS. 14 to 33 are views illustrating exemplary smart systems having various structures according to an embodiment of the present disclosure.

### DETAILED DESCRIPTION

While illustrative embodiments have been illustrated and described, it will be appreciated that various changes can be made therein without departing from the spirit and scope of the disclosure.

Hereinafter, an embodiment will be described in detail with reference to the accompanying drawings.

A smart system according to embodiments of the present disclosure may be implemented in the form of a robot that is deployed in a large building and capable of performing various functions.

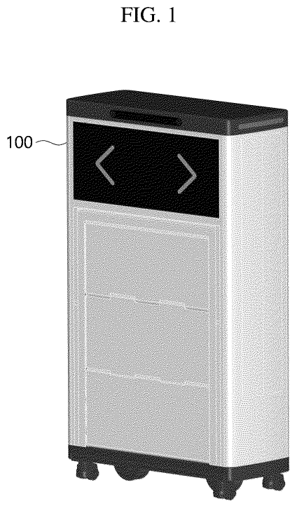

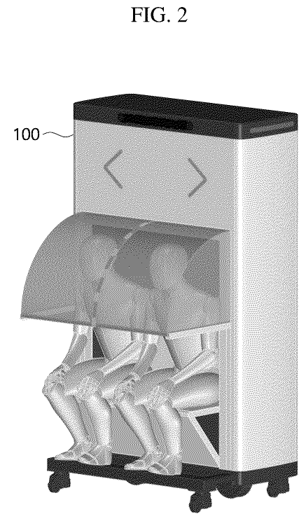

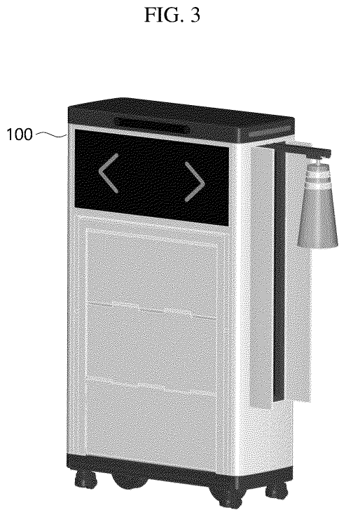

FIGS. 1 to 3 are views illustrating an example of implementation of a smart system according to an embodiment of the present disclosure. FIGS. 1 to 3 show smart systems 100 in different modes. FIG. 1 shows a smart system 100 in a kiosk mode, FIG. 2 shows a smart system 100 in a boarding mode, and FIG. 3 shows a smart system 100 in a rescue mode. Each mode will be described in further detail later.

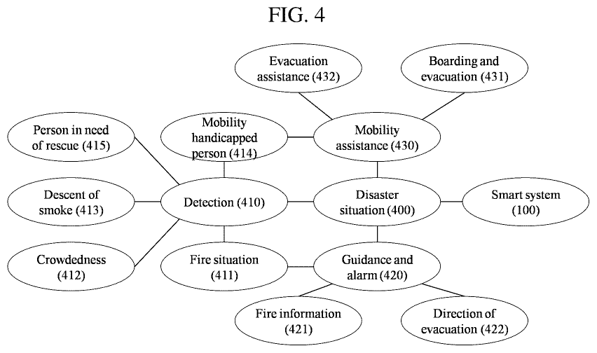

FIG. 4 is a view illustrating an example of functions of a smart system in a disaster situation according to an embodiment of the present disclosure. FIG. 4 is a view illustrating an example of functions of a smart system 100 that are required in a disaster situation 400. The functionality of the smart system 100 may fall roughly into such functions as detection 410, guidance and alarm 420, and mobility assistance 430.

In relation the detection function 410, the smart system 100 may include a function for detecting a fire situation 411 or receiving information on it from an external entity (e.g., an integrated control center, an administrator terminal, and the like of a large building). Information detected or received on the fire situation 411 may include the location of the fire and/or the direction of evacuation. A function for detecting the fire situation 411 may work in conjunction with the guidance and alarm function 420. To this end, the smart system 100 may include at least one sensor (e.g., a temperature sensor, a flame sensor, a smoke sensor, etc.) for detecting the fire situation 411 and/or a communication part for communication with the outside.

Moreover, in relation to the detection function 410, the smart system 100 may include a function for detecting crowdedness 412. In this instance, the smart system 100 may detect crowdedness 412 and restrict or initiate movement by itself. To this end, the smart system 100 may include a camera, and may further include a function for analyzing an image inputted through the camera. The smart system 100 may determine crowdedness 412 based on the number of people obtained by analyzing an image inputted through the camera. For example, if the smart system 100 initiates movement when the crowdedness 412 of a large building is too high, the smart system 100 may be an obstacle to people. Accordingly, the smart system 100 may initiate movement when the crowdedness 412 is below a preset threshold after evacuation has progressed to some extent at an early stage.

In addition, in relation to the detection function 410, the smart system 100 may include a function for detecting a descent 413 of smoke. To this end, the smart system 100 may further include an upper camera for detecting a descent 413 of smoke. The smart system 100 may check whether vision is blocked or not by analyzing an image inputted through the upper camera. Upon detecting a descent 413 of smoke, the smart system 100 may prompt users to bend down through the guidance and alarm function 420 and provide a breathing apparatus such as a respirator or actuate a smoke blocking device for a person located farthest who is in need of rescue. The breathing device and the smoke blocking device will be described in more detail later.

Furthermore, in relation to the detection function 410, the smart system 100 may search for a mobility handicapped person 414 or a person 415 in need of rescue. If the crowdedness 412 is below a preset threshold, the smart system 100 may initiate movement and move to the farthest location from a safe zone and then search for a mobility handicapped person 414 or a person 415 in need of rescue while moving back to the safe zone. The smart system 100 may provide a structure that allows for boarding of a mobility handicapped person 414, as in the boarding mode explained with reference to FIG. 2. Also, according to an embodiment, the smart system 100 may provide a handle or the like for the mobility handicapped person 414 to assist the mobility handicapped person 414 during transportation. On the other hand, after the mobility handicapped person 414 has been transported, the smart system 100 may move to the location of a first person found who is in need of rescue to perform a second search. If there are multiple people 415 in need of rescue, the smart system 100 may deploy a location marking device around the people 415 in need of rescue, that is capable of sending location information to an integrated control center or the like. Also, a visual and auditory signaling device implemented in the smart system 100 may be actuated to help a rescue team quickly recognize a person 415 in need of rescue.

In relation to the guidance and alarm function 420, the smart system 100 may output fire information 421. For example, the smart system 100 may include a display for showing the location of the fire it has received. As another example, the smart system 100 may include a speaker for auditorially outputting information on the location of the fire.

Furthermore, in relation to the guidance and alarm function 420, the smart system 100 may output information on the direction 422 of evacuation. For example, the smart system 100 may indicate a safe escape route through the display in an early stage of fire. Also, when a mobility handicapped person 414 is boarding, the smart system 100 may guide the evacuation of other users while moving along an escape route.

In relation to the mobility assistance function 430, the smart system 100 may provide a structure for boarding and evacuation 431 that allows for boarding of a mobility handicapped person 414, as previously explained.

Furthermore, in relation to the mobility assistance function 430, the smart system 100 may further provide a structure for evacuation assistance 432 such as a handle for a mobility handicapped person 414 to hold onto.

In some embodiments, the smart system 100 may be implemented to perform at least some of the functions explained with reference to FIG. 4. As an example, the structure for evacuation assistance 432 such as a handle may be excluded from the smart system 100.

Furthermore, the smart system 100 may include cameras at upper and lower ends, and may further include a LiDAR (light detection and ranging) sensor. The camera at the upper end may be used to detect a descent 413 of smoke. Also, the camera at the lower end may be used to measure crowdedness 412. Also, the camera at the lower end and/or the LiDAR sensor may be used for the movement of the smart system 100. Technologies such as tracking of the movement and location of a robot in a large building will be understood through well-known technologies.

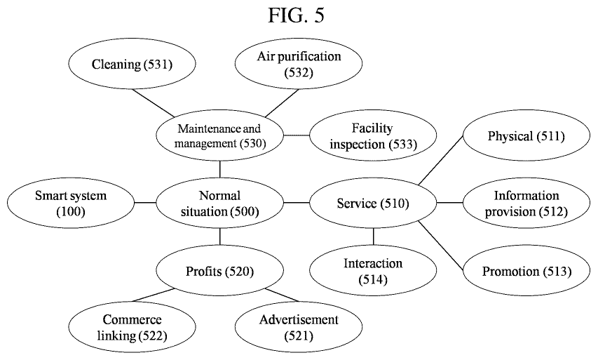

FIG. 5 is a view illustrating an example of functions of a smart system in a normal situation according to an embodiment of the present disclosure. FIG. 5 is a view illustrating an example of functions of the smart system 100 that are required in a normal situation 500. In a normal situation 500, the functionality of the smart system 100 may fall roughly into such functions as service 510, profits 520, and maintenance and management 530.

In relation to the service function 510, the smart system 100 may provide a physical function 511 for providing assistance in moving a heavy load and assisting the mobility of a mobility handicapped person 414. Also, as a way to perform the physical function 511, the smart system 100 may stay on standby at a designated location at normal times and detect an unusual situation within a range of detection from that location. For example, the smart system 100 may detect an unusual situation, such as when a person gets too close to a screen door or when a collapsed person shows no movements for a certain period of time. Also, the smart system 100 may convey information detected of such an unusual situation externally to an integrated control center, an administrator terminal, and the like.

Moreover, in relation to the service function 510, the smart system 100 may include an information provision function 512 for providing various information related to a large building. As an example, a smart system 100 placed at a subway station may provide various information such as a transfer route guide, a guide to getting around the station, information on facilities and shops at the station, and train information. As an example, in relation to the transfer route guide, the smart system 100 may show an image such as an advertisement through a display, analyze an image inputted through a camera, and upon detecting an arrival of a vehicle, automatically convert the information shown through the display from advertisement to transfer route guide. Also, in relation to the guide to getting around the station, the smart system 100 may work in conjunction with apps on users' smartphones by using a tag (e.g., a QR code) or the like. In this way, the smart system 100 may spare users the trouble of searching for a destination from the current location and choosing the best route, but may immediately show a walking route to the destination from the activation of the app, just by reading a tag once. The tag may be created for each destination so as to provide information on a route to a particular destination. Also, in relation to the information on facilities and shops at the station, the smart system 100 may include a function of presenting a first-person perspective 3D image simulation of a route from the current location to a searched location. Also, in relation to the train information, the smart system 100 may provide users with information such as estimated time of arrival, duration, fast transit point, crowdedness of vehicle, and/or women-only train carriages (for example, through the display).

In addition, in relation to the service function 510, the smart system 100 may include a promotion function 513 for introducing the functionality of the smart system 100. In this instance, the smart system 100 may adjust the ratio of advertisements and introductions on the display depending on the crowdedness 412. As an example, the smart system 100 may increase the ratio of advertisements on the display as the level of crowdedness 412 becomes higher, and may increase the ratio of introductions to the functionality of the smart system 100 on the display as the level of crowdedness 412 becomes lower.

Furthermore, in relation to the service function 510, the smart system 100 may provide an interaction function 514 such as taking photographs with users, making conversation, and providing content to users using generative AI.

Furthermore, the smart system 100 may further include an advertisement display function 521, a commerce linking function 522, and the like, as profit-making functions 520. The commerce linking function 522 may include a function for booking a seat at a restaurant within a large building, a function for ordering food, and a function for linking to a product purchase page of an advertised product. For example, the smart system 100 may provide users with a tag for purchasing a product currently being shown through the advertisement display function 521.

Furthermore, in relation to the maintenance and management function 530, the smart system 100 may include a cleaning function 531 as in cleaning the floor and an air purification function 532 as in an air purifier. Also, the smart system 100 may include a facility inspection function 533 for inspecting facilities at times other than the operating hours of the large building. For example, the smart system 100 may provide a function of inspecting lighting, facilities, firefighting equipment, signage, etc. within the station and externally informing of the expiration of the service life of the firefighting equipment on a certain floor or directly correcting information on the service life of the firefighting equipment.

In some embodiments, the smart system 100 may be implemented to perform at least some of the functions explained with reference to FIG. 4. As an example, since the functions for the normal situation 500 have lower priority than the functions for the disaster situation 400, such functions as the cleaning function 531, the air purifying function 532, and the physical function 511 may be excluded from the smart system 100 if necessary.

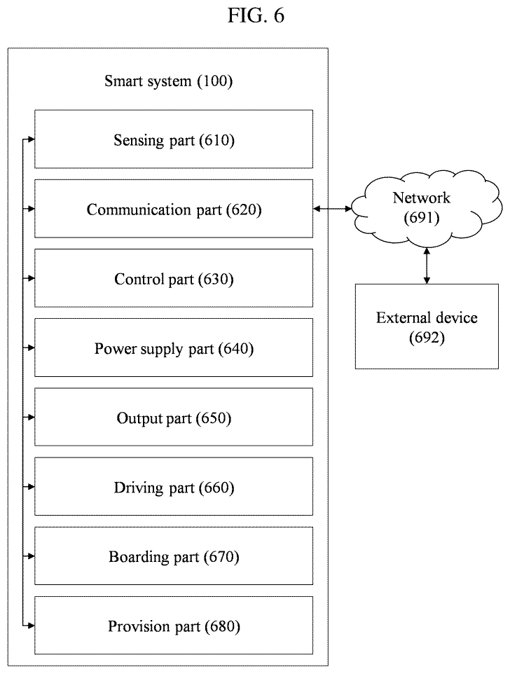

FIG. 6 is a view illustrating an example of an internal configuration of a smart system according to an embodiment of the present disclosure. The smart system 100 according to the present embodiment may include a sensing part 610, a communication part 620, a control part 630, a power supply part 640, an output part 650, a driving part 660, a boarding part 670, and a provision part 680.

The smart system 100 may be implemented to have a structure and configuration that do not obstruct users' path on an evacuation route in a large building both at normal times and at an early stage of a disaster. The height of the smart system 100 may be determined based on the position of an upper camera which detects a descent of smoke from above and the position of a display included in the output part 650. Also, the width of the smart system 100 may be determined based on a structure capable of getting up to four people (adults) aboard and seated in case of an emergency. For example, the width of the smart system 100 may be determined based on an average shoulder width, and the average shoulder width of a grown man is about 40 cm.

Given the position of the camera, the size of the display, and the boarding capacity of four people, the size of the smart system 100 may be an obstacle to the movement of users in case of an emergency. Accordingly, as previously explained, the smart system 100 is deployed at a designated place without moving at normal times and at an early stage of a disaster, and may move when the crowdedness 412 drops to a certain level or below after a disaster situation 400 has occurred and perform functions corresponding to the disaster situation 400.

The sensing part 610 may include cameras at upper and lower portions of the smart system 100, a LiDAR sensor, and so on. In some embodiments, the sensing part 610 may further include a sensor (e.g., a temperature sensor, a flame sensor, a smoke sensor, etc.) for detecting fire. Additionally, the sensing part 610 may include a module (e.g., an indoor positioning system) for accurately locating the smart system 100.

The communication part 620 may include a communication module for communicating with an external device 692 over a network 691. The external device 692 may correspond to a server apparatus, an administrator terminal, or the like of an integrated control center for a large building. The network 691 may include one or more of such networks as PAN (personal area network), LAN (local area network), CAN (campus area network), MAN (metropolitan area network), WAN (wide area network), BBN (broadband network), and the internet, for example. Also, the network 691 may include, but not limited to, one or more of network topologies, including a bus network, a star network, a ring network, a mesh network, a star-bus network, a tree or hierarchical network, etc.

The smart system 100 may receive information on a fire situation such as the location of the fire and/or the direction of evacuation from the external device 692 through the communication part 620, and may convey to the external device 692 through the communication part 620 information related to the current status of the smart system 100 or information detected by the smart system 100 through a sensor.

The control part 630 may control the operations of the sensing part 610, the communication part 620, the power supply part 640, the output part 650, the driving part 660, the boarding part 670, and the provision part 680. The control part 630 may be implemented by including at least one processor and at least one memory.

The memory is a computer-readable recording medium, and may include a permanent mass storage device, such as random access memory (RAM), read only memory (ROM), and a disk drive. Here, the permanent mass storage device, such as ROM and a disk drive, is a separate permanent storage device which is distinct from the memory, and may be included in the control part 630. Also, an operating system and at least one program code may be stored in the memory. Such software components may be loaded onto the memory from another computer-readable recording medium separate from the memory. Such a separate computer-readable recording medium may include a computer-readable recording medium such as a floppy drive, a disk, a tape, a DVD/CD-ROM drive, a memory card, etc. In other embodiments, the software components may be loaded onto the memory, not through a computer-readable recording medium but through a communication interface. For example, the software components may be loaded onto the memory of the control part 630 based on a computer program installed by files received over the network 691 and the communication part 620.

The processor may be configured to process computer program instructions by performing basic arithmetic, logic, and input/output operation. The instructions may be provided to the processor by the memory or the communication interface. For example, the processor may be configured to execute the instructions received according to a program code stored in a recording device such as the memory.

The power supply part 640 may provide power to the sensing part 610, the communication part 620, the control part 630, the output part 650, the driving part 660, the boarding part 670, and the provision part 680. At normal times and at an early stage of an emergency, the power supply part 640 at its installation position may operate to charge a battery with electric power supplied in a wired manner. When the power supply part 640 is moving due to an emergency, it may operate by using the charged battery.

The output part 650 may include a display for presenting evacuation guide, advertisement, and/or service functions. The size of the display may be in compliance with standards for typical large-sized kiosks for providing guidance, but is not limited to them. Also, the output part 650 may include an output device such as a speaker, a warning light, etc. for providing guidance or an alert.

The driving part 660 may include a structure for moving the smart system 100. As previously described, FIGS. 1 to 3 show an example of a structure for moving the smart system 100 by wheels. Technologies related to the movement of robots will be understood by well-known technologies.

The boarding part 670 may provide a structure capable of getting up to four people aboard and seated, as previously stated. As can be seen from FIGS. 1 and 2, this seated-type boarding structure may obstruct users' path at normal times, and therefore components included in the smart system 100 may be configured in such a way as to be pulled out in case of an emergency.

The provision part 680 may provide a smoke blocking device, an emergency respirator, etc. for a person in need of rescue, a mobility handicapped person, or a passenger, and may deploy a location marking device that helps locate a person in need of rescue. The previous embodiment described with reference to FIG. 3 gives a brief description of a function that provides a smoke blocking device. The provision part 680 will be described in further detail later.

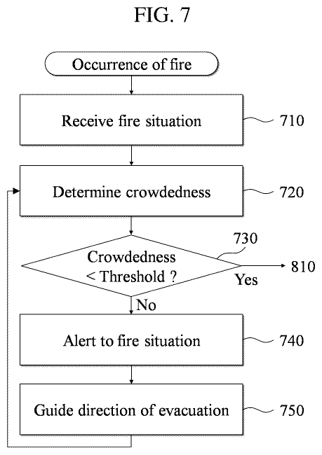

FIGS. 7 to 9 are views illustrating an example of an operation scenario of a smart system according to an embodiment of the present disclosure.

The steps 710 to 750 in FIG. 7 may be steps for supporting quick evacuation of multiple users at an early stage of fire.

The step 710 of receiving a fire situation may be an example of a process in which, when a fire situation occurs in a large building, the smart system 100 receives information on a fire situation such as the location of the fire and/or the direction of evacuation from an external device 692 such as a server or the like of an integrated control center through the communication part 620. The fire situation may develop into an emergency situation. In this case, the information on the fire situation may include the location of the emergency situation and evacuation route information.

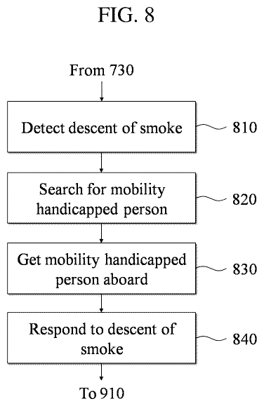

The step 720 of determining crowdedness may be an example of a process in which the smart system 100 determines crowdedness based on the number of users by analyzing an image inputted through a lower camera and/or an upper camera. In this case, in the step 730, the smart system 100 may determine whether the crowdedness is below a preset threshold or not. If the crowdedness is not below the threshold, the smart system 100 may perform the step 740 of alerting to a fire situation. Also, if the determined crowdedness is below the preset threshold, the smart system 100 may perform the step of detecting a descent of smoke as shown in FIG. 8. As previously explained, when there are a lot of users, the movement of the smart system 100 may be an obstacle to the users. Accordingly, the smart system 100 may provide information to the users while remaining in its place without moving, if the crowdedness is high (above a threshold).

The step 740 of alerting to a fire situation may be an example of a process in which the smart system 100 alerts users to a fire situation through the output part 650. As an example, the smart system 100 may show the location of the fire through the display and output auditory information through a speaker to alert users to the occurrence of a fire situation.

The step 750 of guiding the direction of evacuation may be an example in which the smart system 100 indicates an evacuation route to a safe area through the output part 650. As an example, the smart system 100 may show a safe evacuation route through the display or show the direction to be followed by users at that moment simply by an arrow or the like. The evacuation route may be set directly by the smart system 100 based on the current location and the location of the fire, or may be preset by a server or the like of an integrated control center and conveyed to the smart system 100. The current location of the smart system 100 may be measured by an indoor positioning system, for example.

The steps 810 to 840 of FIG. 8 may be steps for supporting safe evacuation of a mobility handicapped person at an intermediary stage of a disaster in which crowdedness during evacuation begins to decrease.

The step 810 of detecting a descent of smoke may be an example of a process in which the smart system 100 detects a vertical field of vision being blocked by smoke from fire by an upper camera. Although the embodiment of FIGS. 7 and 8 have been described with an example in which this step is performed when crowdedness is below a preset threshold, the step 810 of detecting a descent of smoke and the later step 840 of responding to a descent of smoke may be performed even if the crowdedness is not below the preset threshold. As an example, the step 740 of alerting to a fire situation, the step 750 of guiding the direction of evacuation, and the step 810 of detecting a descent of smoke may be performed in parallel at an early stage of response to the fire. Also, the step 840 of responding to a descent of smoke may be triggered as smoke descending to a certain height or below is detected through the step 810 of detecting a descent of smoke.

The step 820 of searching for a mobility handicapped person may be an example of a process in which, as the crowdedness falls below a preset threshold, the smart system 100 searches for a mobility handicapped person and a person in need of rescue while moving by means of the driving part 660. In this case, the smart system 100 may be moved based on information from an indoor positioning system and a LiDAR sensor and images inputted from upper and lower cameras.

The step 830 of getting a mobility handicapped person aboard may be an example of a process in which the smart system 100 guides a mobility handicapped person aboard the boarding part 670 and transport the mobility handicapped person to a safe zone after the mobility handicapped person has boarded. To this end, the smart system 100 may first move to the farthest location from the safe zone and then start searching for a mobility handicapped person (and a person in need of rescue) once it returns to the safe zone. The mobility handicapped person may refer to a user who is deemed having no ability to move on their own at the time of search. The smart system 100 may output to the output part 650 information for guiding a mobility handicapped person aboard the boarding part 670, and, after the mobility handicapped person has boarded, may control the driving part 660 to transport the mobility handicapped person to a safe zone.

The step 840 of responding to a descent of smoke may be an example of a process in which the smart system 100 outputs through the output part 650 information for prompting users to bend down during evacuation when their field of vision is blocked by smoke and provides a mobility handicapped person or a person in need of rescue with an emergency breathing apparatus (a respirator or a breathing aid such as an air shield to be described later).

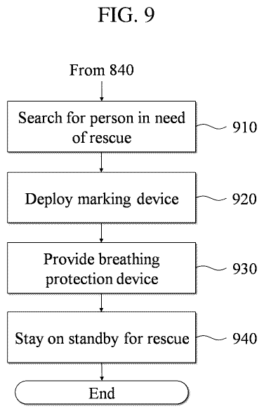

The steps 910 to 940 shown in FIG. 9 may be steps for supporting survival and rescue of a person in need of rescue at a later stage of an emergency as in the initiation of entry for firefighting and rescue.

The step 910 of searching for a person in need of rescue may be an example of a process in which the smart system 100 performs a second search while moving to the location of a person in need of help previously found in the step 820 of searching for a mobility handicapped person.

The step 920 of deploying a marking device may be an example of a process in which, when there are multiple people in need of rescue, the smart system 100 deploys a marking device at the locations of the people in need of rescue. The marking device may include a function for enabling firefighting and rescue teams to quickly identify the location of a person in need of rescue (e.g., a function for outputting light or sound). Also, the smart system 100 may convey information on the deployment location of the marking device to an external device 692. Such information may be conveyed to the firefighting and rescue teams to help them quickly find a person in need of rescue.

The step 930 of providing a breathing protection device may be an example of a process in which the smart system 100 provides a breathing protection device to people in need of rescue in the order of farthest to nearest. The breathing protection device may include a smoke blocking device. Alternatively, it may include a device for supplying oxygen directly to a person who needs a supply of oxygen.

The step 940 of staying on standby for rescue may be an example of a process in which the smart system 100 stays on standby for rescuing people in need of rescue by a rescue team by outputting a visual and/or auditory signal from its location while providing a breathing protection device to a person located farthest who is in need of rescue.

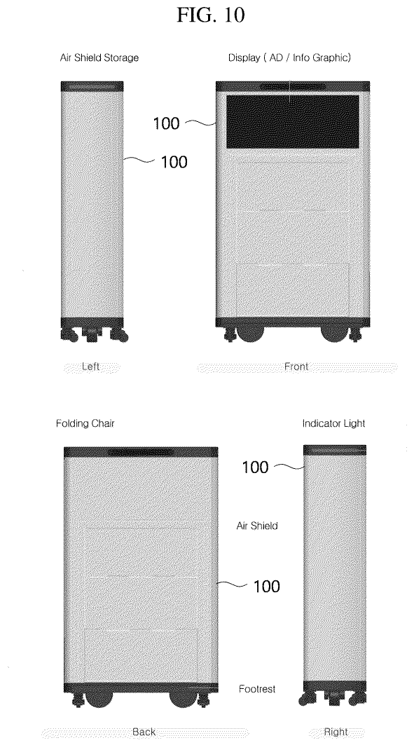

FIG. 10 is a view illustrating an example of an outward appearance of a smart system according to an embodiment of the present disclosure. FIG. 10 shows the left, front, back, and right of the smart system 100. FIG. 10 shows that the smart system 100 may include a structure for allowing a mobility handicapped person to board, an air shield storage, a display, a folding chair, a footrest, an indicator light, and so on. The air shield storage may be a space that stores a protection device for blocking smoke. The air shield storage will be described in further detail later.

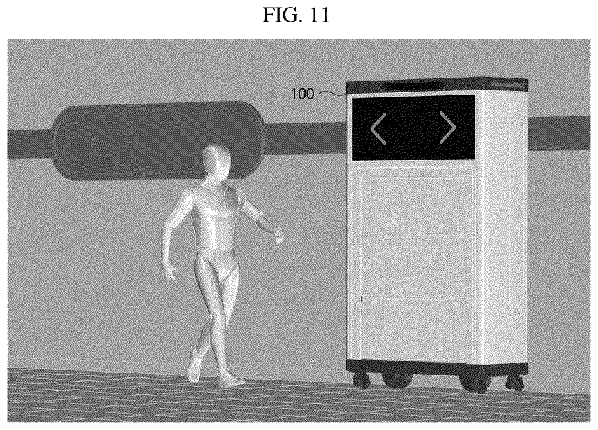

FIG. 11 is a view illustrating an example of a smart system in a kiosk mode according to an embodiment of the present disclosure. As already explained, when there is a large number of users, the movement of the smart system 100 may be an obstacle to the users. Thus, the smart system 100 may operate in a kiosk mode in which it provides the users with information while deployed at a particular location within a facility. The smart system 100 may determine its movability on its own if the crowdedness is below a preset threshold. For example, if the crowdedness is below a preset threshold in a fire situation, the smart system 100 may move to perform the step 820 of searching for a mobility handicapped person. Also, if the crowdedness is below a preset threshold in a normal situation as well, the smart system 100 may move to perform the maintenance and management 530.

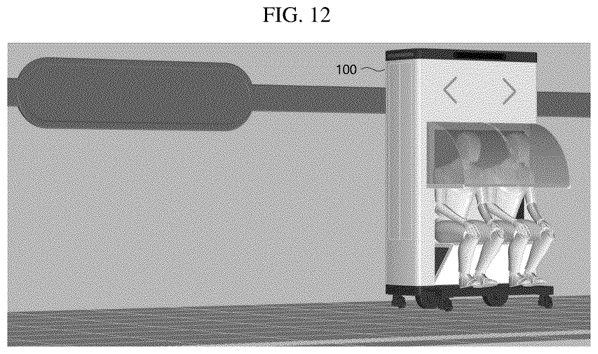

FIG. 12 is a view illustrating an example of a smart system in a rescue mode according to an embodiment of the present disclosure. If the crowdedness in a disaster situation 400 is below a preset threshold, the smart system 100 may get a mobility handicapped person aboard the smart system 100 through the steps 820 and 830 of searching for a mobility handicapped person and getting the mobility handicapped person aboard and then move to a safe zone. FIG. 12 shows an example of such the moving.

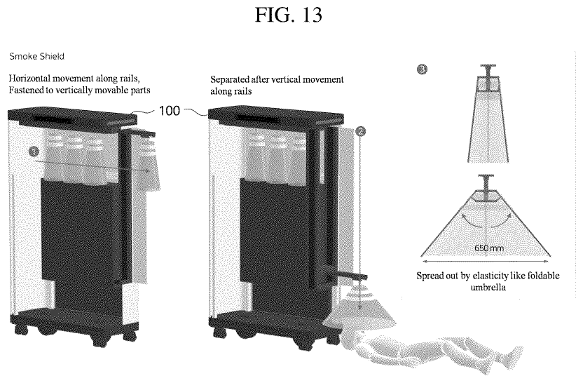

FIG. 13 is a view illustrating an example of providing an air shield according to an embodiment of the present disclosure. The smart system 100 may include a storage for storing an air shield (or a smoke shield) as in the above-mentioned air shield storage and a function for putting an air shield on the head of a person in need of rescue. The air shield may be converted from a folded state to an unfolded state due to its elasticity as illustrated in FIG. 13, thereby covering the head of the person in need of rescue and protecting him or her from smoke, etc. from fire.

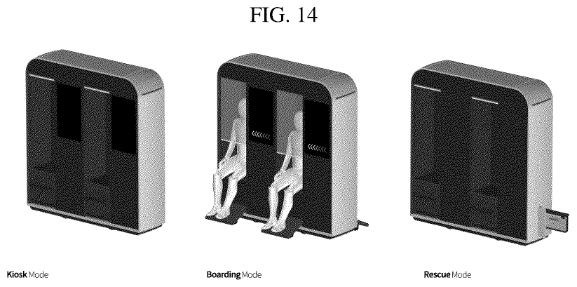

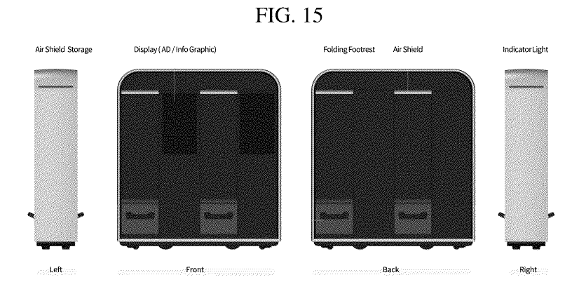

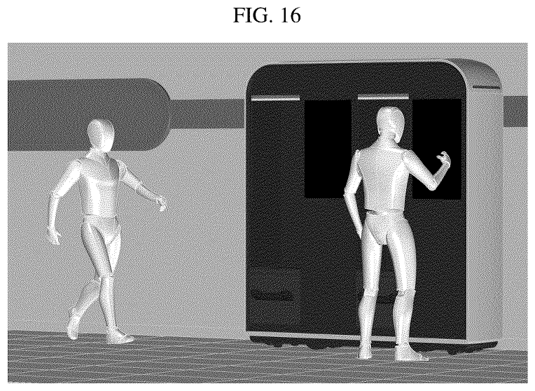

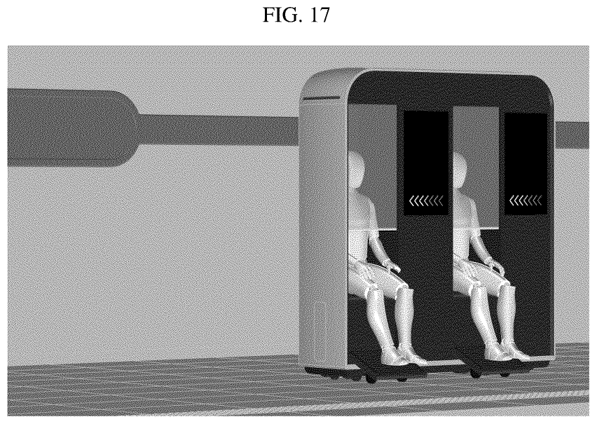

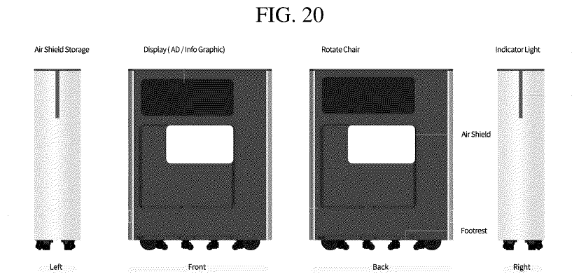

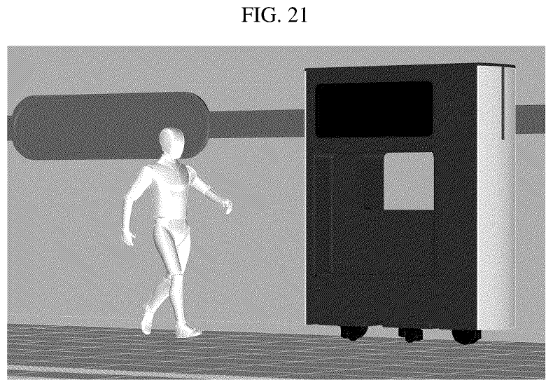

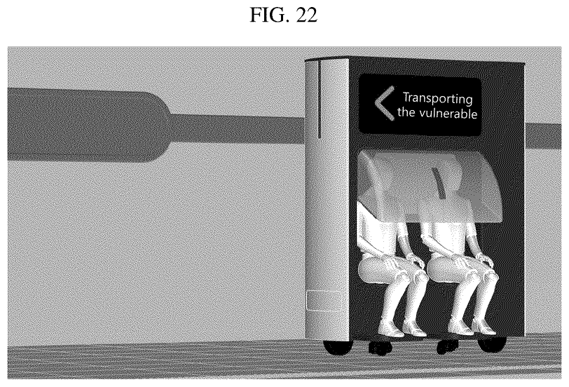

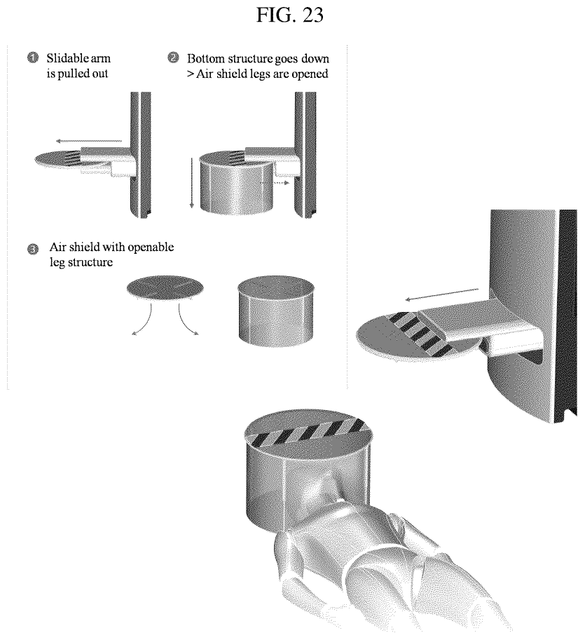

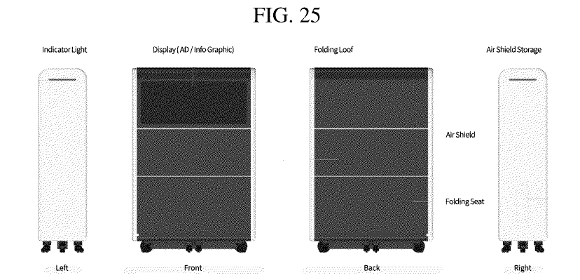

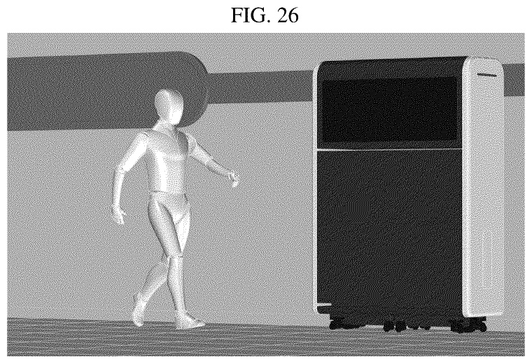

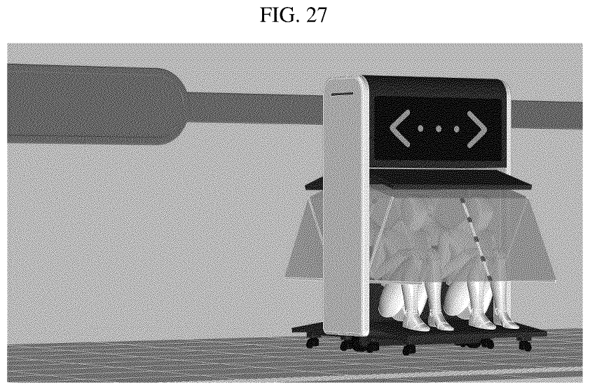

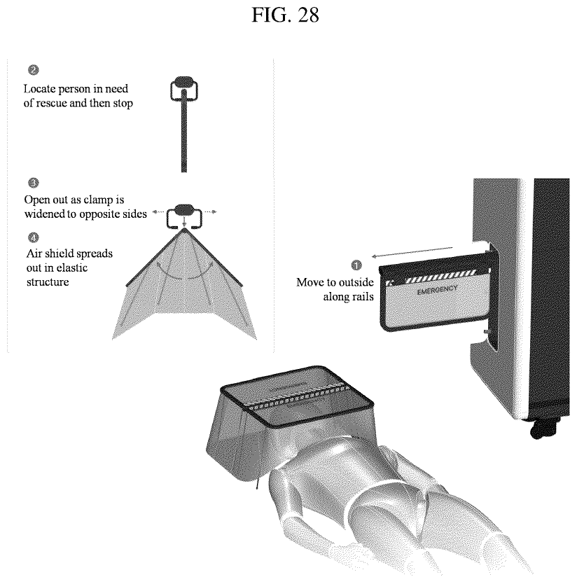

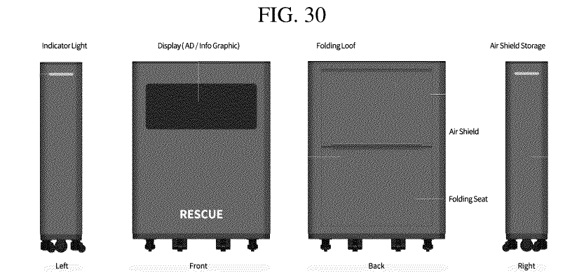

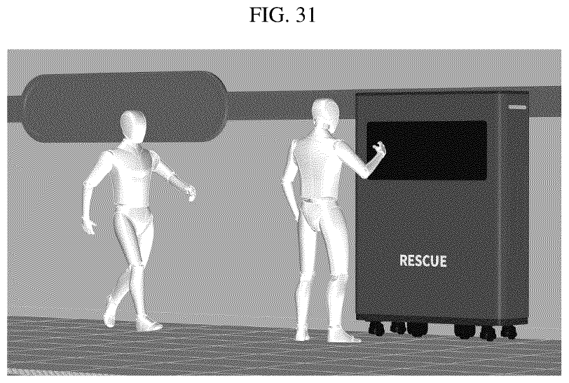

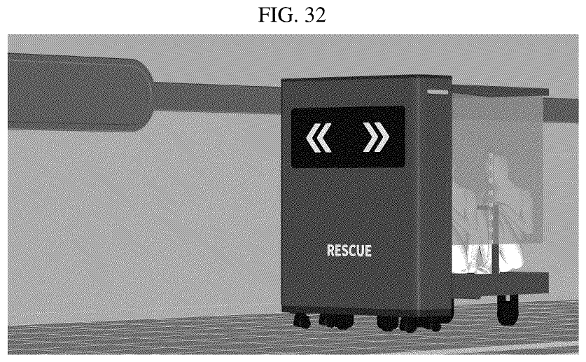

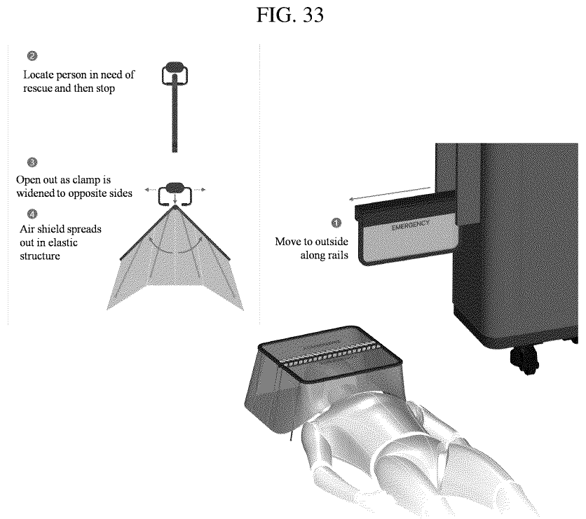

FIGS. 14 to 33 are views illustrating exemplary smart systems having various structures according to an embodiment of the present disclosure.

FIGS. 14 to 18 show an example of a mobility type smart system featuring a zigzag layout, capable of efficient space utilization that gets a mobility handicapped person aboard in a zigzag layout. Also, this embodiment shows an example of providing an air shield that spreads out by elasticity as the clamp is widened to opposite sides.

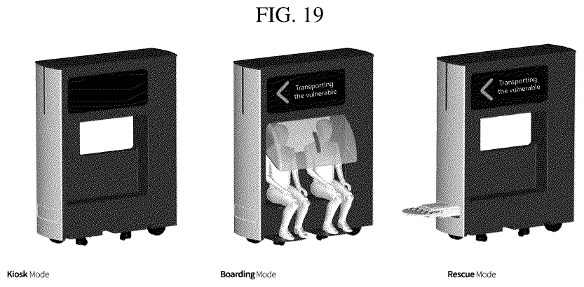

The embodiment in FIGS. 19 to 23 shows an example of a smart system featuring a layout in which main features (seats, footrests, auxiliary wheels, etc.) can be transformed with a single rotating shaft. Also, this embodiment show an example of providing an air shield that spreads out as a slidable arm is pulled out and its bottom structure goes down.

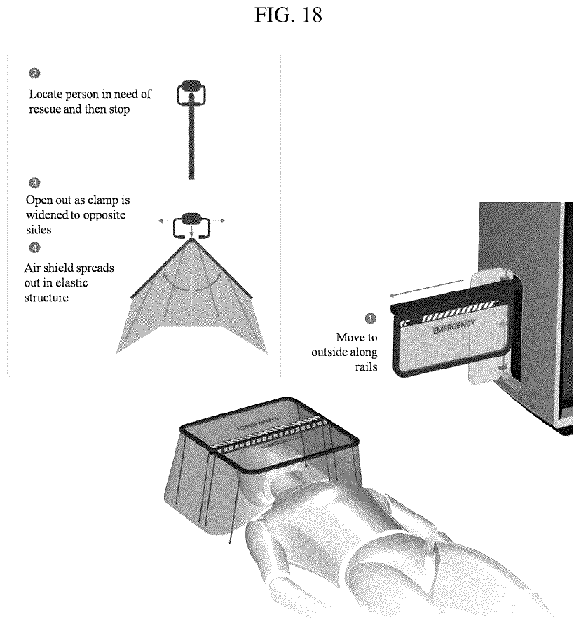

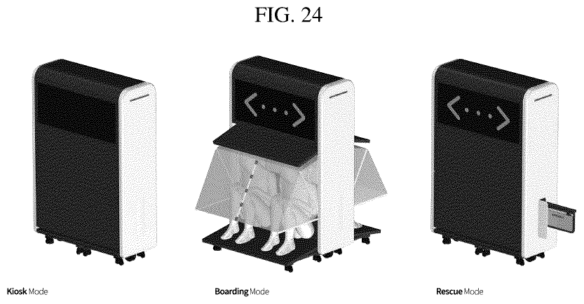

The embodiment in FIGS. 24 to 28 shows an example of a smart system compact in size and featuring a layout in which a small but efficient boarding space can be secured through a vertical rotating structure. Also, this embodiment shows an example of providing an air shield to which the structure according to the embodiment of FIG. 18 is applied.

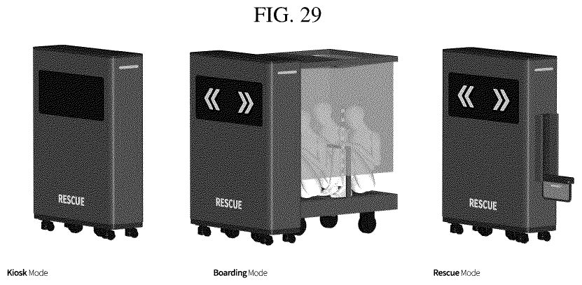

The embodiment in FIGS. 29 to 33 shows an example of a smart system having a double folding structure and featuring a layout specialized to rescue people. Also, this embodiment shows an example of providing an air shield to which the structure according to the embodiment of FIG. 18 is applied.

In this way, according to embodiments of the present disclosure, a smart system for evacuation and rescue support in case of a large building disaster and an operation method for the smart system.

The aforementioned system or apparatus may be implemented in the form of a hardware component, a software component, or a combination of a hardware component and a software component. For example, the apparatus and components described in the embodiments may be implemented using one or more general-purpose computers or special-purpose computers, like a processor, a controller, an arithmetic logic unit (ALU), a digital signal processor, a microcomputer, a field programmable gate array (FPGA), a programmable logic unit (PLU), a microprocessor or any other device capable of executing or responding to an instruction. The processor may perform an operating system (OS) and one or more software applications executed on the OS. Furthermore, the processor may access, store, manipulate, process and generate data in response to the execution of software. For convenience of understanding, one processor has been illustrated as being used, but a person having ordinary skill in the art may understand that the processor may include a plurality of processing elements and/or a plurality of types of processing elements. For example, the processor may include a plurality of processors or a single processor and a single controller. Furthermore, a different processing configuration, such as a parallel processor, is also possible.

Software may include a computer program, code, an instruction or a combination of one or more of them and may configure a processor so that it operates as desired or may instruct the processor independently or collectively. The software and/or data may be embodied in a machine, component, physical device, virtual equipment or computer storage medium or device of any type in order to be interpreted by the processor or to provide an instruction or data to the processor. The software may be distributed to computer systems connected over a network and may be stored or executed in a distributed manner. The software and data may be stored in one or more computer-readable recording media.

The method according to the embodiments may be implemented with program instructions which may be executed through various computer means, and may be recorded in computer-readable media. The computer-readable media may also include, alone or in combination, the program instructions, data files, data structures, and the like. The media may persistently store a computer-executable program or temporarily store the computer-executable program for execution or downloading. The media may be various recording means or storage means formed by a single piece of hardware or a combination of several pieces of hardware. The media are not limited to media directly connected to a certain computer system, but may be distributed over a network. Examples of the media may be those configured to store program instructions, including magnetic media such as hard disks, floppy disks, and magnetic tapes, optical media such as CD-ROMs and DVDs, and magneto-optical media such as floptical disks, ROM, RAM, and flash memory. Furthermore, other examples of the medium may include an app store in which apps are distributed, a site in which other various pieces of software are supplied or distributed, and recording media and/or store media managed in a server. Examples of the program instructions may include machine-language code, such as code written by a compiler, and high-level language code executable by a computer using an interpreter.

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in a different order than described above, and/or the aforementioned elements, such as systems, structures, devices, or circuits, are combined or coupled in different forms and modes than as described above or be substituted or switched with other components or equivalents.

Therefore, other implementations, other embodiments, and equivalents to the claims are within the scope of the following claims.

1. A smart system deployed in a large building, comprising:
a communication part that, in the event of an emergency situation, receives information on an emergency situation from an integrated control center of the large building;
a sensing part including at least one camera;
an output part that outputs information;
a driving part that moves the smart system;
a boarding part for getting a user in the large building aboard; and
a control part that controls the communication part, the sensing part, the output part, and the driving part,
wherein the control part determines crowdedness by analyzing an image inputted through the at least one camera,
wherein the crowdedness is determined based on the number of users identified through an image inputted through the at least one camera, in such a manner that, the more the users, the higher the level of crowdedness,
wherein the control part operates in a kiosk mode for providing information while remaining in place without moving so as not to obstruct an evacuation of the user. and outputs information through the output part, if the crowdedness is equal to or above a preset threshold, and, in the kiosk mode, the control part outputs, through the output part, information on occurrence location of the emergency situation and information on a direction of evacuation as information on the emergency situation,
wherein the control part operates in a rescue mode and moves the smart system through the driving part, if the crowdedness is below the preset threshold,
wherein the control part searches for a mobility handicapped person or a person in need of rescue by analyzing an image inputted through the at least one camera,
wherein the at least one camera includes an upper camera located at an upper portion of the smart system for detecting descending smoke,
wherein the control part:
analyzes images input through the upper camera to detect descending smoke that falls below a preset height, and
upon detection of the descending smoke,
outputs information via the output part to induce users to evacuate in a low posture, and triggers a descending smoke response action that provides a breathing aid to a mobility handicapped person or a person in need,
wherein the descending smoke response action is triggered even when the crowdedness is not below a threshold value,
wherein the breathing aid includes an air shield, and
when the descending smoke response action is triggered, the control part is controlled to protect a person in need fallen near the smart system from the smoke by covering a head of the person in need with the air shield.

2-3. (canceled)

4. The smart system of claim 1, wherein, in the rescue mode, the control part outputs information for guiding a found mobility handicapped person aboard the boarding part through the output part, and once the mobility handicapped person is aboard the boarding part, controls the transportation of the mobility handicapped person to a safe zone by controlling the driving part.

5. The smart system of claim 1, wherein the control part additionally searches for a person in need of rescue while moving to the location of a found person in need of rescue.

6. The smart system of claim 1, wherein the smart system further comprises a provision part providing a marking device configured to output visual or auditory information,
wherein the control part deploys the marking device at the location of the found person in need of rescue by controlling the provision part, and sends information on the location to the integrated control center through the communication part.

7. (canceled)

8. The smart system of claim 1, wherein the control part controls the smart system in such a way as to stay on standby around the found person in need of rescue while outputting visual or auditory information through the output part.

9. The smart system of claim 1, wherein the boarding part is transformed into a configuration that allows the user to board as components disposed inside the smart system are pulled out of the smart system according to control from the control part.

10-12. (canceled)

13. An operation method for a smart system deployed in a large building, the smart system comprising a communication part, a sensing part, an output part, a driving part, a boarding part, and a control part, and the operation method comprising:
receiving information on an emergency situation from an integrated control center of the large building through the communication part in the event of an emergency situation;
determining crowdedness, by means of the control part, by analyzing an image inputted through at least one camera included in the sensing part, wherein the crowdedness is determined based on the number of users identified through an image inputted through the at least one camera, in such a manner that, the more the users, the higher the level of crowdedness;
if the crowdedness is equal to or above a preset threshold, operating in a kiosk mode for providing information while remaining in place without moving so as not to obstruct an evacuation of the user and outputting information through the output part, by means of the control part, in the kiosk mode, the control part outputs, through the output part, information on occurrence location of the emergency situation and information on a direction of evacuation as information on the emergency situation;
if the crowdedness is below the preset threshold, operating in a rescue mode and moving the smart system through the driving part, by means of the control part; and
searching for a mobility handicapped person or a person in need of rescue, by means of the control part, by analyzing an image inputted through the at least one camera,
wherein the at least one camera includes an upper camera located at an upper portion of the smart system for detecting descending smoke,
wherein the operation method further comprises:
analyzing images input through the upper camera to detect descending smoke that falls below a preset height, and
upon detection of the descending smoke,
outputting information via the output part to induce users to evacuate in a low posture, and triggering a descending smoke response action that provides a breathing aid to a mobility handicapped person or a person in need,
wherein the descending smoke response action is triggered even when the crowdedness is not below a threshold value,
wherein the breathing aid includes an air shield, and
wherein the operation method further comprises:
when the descending smoke response action is triggered, protecting a person in need fallen near the smart system from the smoke by covering a head of the person in need with the air shield.

14-15. (canceled)

16. The operation method of claim 13, wherein the moving of the smart system includes:
in the rescue mode, outputting information for guiding a found mobility handicapped person aboard the boarding part through the output part; and
once the mobility handicapped person is aboard the boarding part, controlling the transportation of the mobility handicapped person to a safe zone by controlling the driving part.

17. The operation method of claim 13, further comprising additionally searching for a person in need of rescue while moving to the location of a found person in need of rescue.

18. The operation method of claim 13, wherein the smart system further comprises a provision part providing a marking device configured to output visual or auditory information,
wherein the operation method further comprises deploying the marking device at the location of the found person in need of rescue by controlling the provision part, and sending information on the location to the integrated control center through the communication part.

19-20. (canceled)
